(19) United States
(12) Patent Application Publication
(10) Pub. No.: US 2017/0292711 A1
(43) Pub. Date: Oct. 12, 2017

(54) GAS STOVE HAVING TEMPERATURE SENSING FUNCTION

(71) Applicant: Oriental System Technology Inc., Hsinchu (TW)

(72) Inventor: Li-Hwei Wang, Taipei City (TW)

(21) Appl. No.: 15/333,806

(22) Filed: Oct. 25, 2016

(30) Foreign Application Priority Data
Apr. 11, 2016 (CN) 201610220368.8

(51) Int. Cl. F24C 3/12; G08C 17/02

(52) U.S. Cl. CPC F24C 3/122; G08C 17/02; F23D 2208/10; H04L 67/12

(57) ABSTRACT

A gas stove having a temperature sensing function comprises a stove body, a temperature sensor and a gas controller. The stove body includes a burner assembly for heating a pot. The temperature sensor includes a thermopile sensor and a signal processor. The thermopile sensor senses infrared rays radiating from the pot and outputs a sensing signal. The signal processor is electrically connected with the thermopile sensor to process the sensing signal and outputs a control signal. The gas controller is electrically connected with the signal processor and adjusts a gas flow supplied to the burner assembly according to the control signal. The aforementioned gas stove senses the temperature of the pot with a non-contact manner.

### BACKGROUND OF THE INVENTION

### 1. Field of the Invention

The present invention relates to a gas stove, particularly to a gas stove having a temperature sensing function.

### 2. Description of the Prior Art

In the past, users often forgot to turn off their gas stoves and caused the pots to be drily heated without water. At present, the manufacturers have developed gas stoves having a temperature sensing function, which can sense the temperature of the pot and interrupt gas supply to avoid danger while the pot temperature is abnormal. Refer to FIG. 6 for a conventional gas stove having a temperature sensing function. In the conventional gas stove 60 having a temperature sensing function, a sensor head 61 is disposed in the center of a burner assembly and able to move up and down. While a pot 100 is heated on the conventional gas stove 60, the sensor head 61 elastically presses against the bottom of the pot 100 to sense the temperature of the pot 100. However, inappropriate contact or dirt on the bottom or is likely to affect the accuracy of temperature sensation of the sensor head 61. Considering the flames of the inner burner may affect the accuracy of the sensor head, only the outer burner 62 is preserved in the conventional gas stove 60. However, such a design decreases the heat energy output by the conventional gas stove 60.

Therefore, how to accurately sense the temperature of a heated pot has become a target the gas stove manufacturers are eager to achieve.

### SUMMARY OF THE INVENTION

The present invention provides a gas stove, which uses a contactless thermolpile sensor to sense the temperature of a pot to prevent sensing accuracy from being degraded by inappropriate contact.

In one embodiment, the gas stove having a temperature sensing function of the present invention comprises a stove body, a temperature sensor and a gas controller. The stove body includes a burner assembly for heating a pot. The temperature sensor includes a thermopile sensor and a signal processor. The thermopile sensor senses the infrared rays radiating from the pot and outputs a sensing signal. The signal processor is electrically connected with the thermopile sensor to process the sensing signal and outputs a control signal. The gas controller is electrically connected with the signal processor and adjusts a gas flow supplied to the burner assembly according to the control signal.

Below, embodiments are described in detail in cooperation with the attached drawings to make easily understood the objectives, technical contents, characteristics and accomplishments of the present invention.

### BRIEF DESCRIPTION OF THE DRAWINGS

FIG. 1 is a diagram schematically showing a gas stove having a temperature sensing function according to one embodiment of the present invention;

FIG. 2 is a diagram schematically showing a temperature sensor according to one embodiment of the present invention

FIG. 3 is a diagram schematically showing a three-stage gas controller according to one embodiment of the present invention;

FIG. 4 is a diagram schematically showing a gas stove having a temperature sensing function according to another embodiment of the present invention;

FIG. 5 is a diagram schematically showing a gas stove having a temperature sensing function according to yet another embodiment of the present invention; and

FIG. 6 is a diagram schematically showing a conventional gas stove having a temperature sensing function.

### DESCRIPTION OF THE PREFERRED EMBODIMENTS

The present invention will be described in detail with embodiments and attached drawings below. However, these embodiments are only to exemplify the present invention but not to limit the scope of the present invention. In addition to the embodiments described in the specification, the present invention also applies to other embodiments. Further, any modification, variation, or substitution, which can be easily made by the persons skilled in that art according to the embodiment of the present invention, is to be also included within the scope of the present invention, which is based on the claims stated below. Although many special details are provided herein to make the readers more fully understand the present invention, the present invention can still be practiced under a condition that these special details are partially or completely omitted. Besides, the elements or steps, which are well known by the persons skilled in the art, are not described herein lest the present invention be limited unnecessarily. Similar or identical elements are denoted with similar or identical symbols in the drawings. It should be noted: the drawings are only to depict the present invention schematically but not to show the real dimensions or quantities of the present invention. Besides, matterless details are not necessarily depicted in the drawings to achieve conciseness of the drawings.

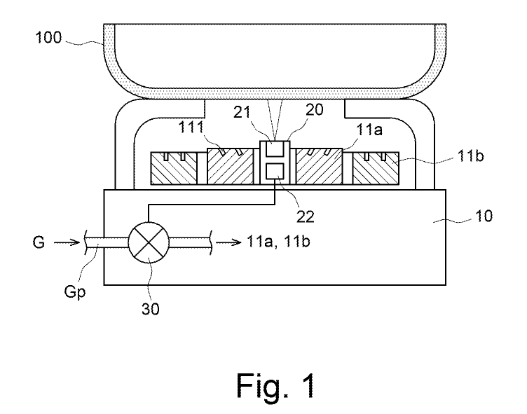

Refer to FIG. 1. In one embodiment, the gas stove having a temperature sensing function of the present invention comprises a stove body 10, a temperature sensor 20, and a gas controller 30. The stove body 10 includes a burner assembly for heating a pot 100. In the embodiment shown in FIG. 1, the burner assembly has an inner annular burner 11a and an outer annular burner 11b, which are disposed almost concentrically. However, the present invention does not limit that the burner assembly must use two concentrically-disposed burners. In the present invention, the burner assembly may include several burners disposed side by side.

The temperature sensor 20 includes a thermopile sensor 21 and a signal processor 22. The thermopile sensor 21 senses the infrared rays radiating from the pot 100 and outputs a sensing signal. The signal processor 22 is electrically connected with the thermopile sensor 21 to process the sensing signal and outputs a control signal. In the embodiment shown in FIG. 1, the temperature sensor 20 is disposed in the center of the inner annular burner 11a and pointed to the bottom of the pot 100 to sense the infrared rays radiating from the pot 100. However, the present invention does not limit that the temperature sensor 20 must be disposed in the center of the inner annular burner 11a. In one embodiment, the temperature sensor 20 and the burner assembly are disposed side by side; in other words, the temperature sensor 20 is disposed beside the burner assembly and pointed to the bottom of the pot 100. The detailed structure of the temperature sensor 20 will be described below.

The gas controller 30 is electrically connected with the signal processor 22 and adjusts a gas flow supplied to the burner assembly according to the control signal output by the signal processor 22. In one embodiment, the gas controller 22 is connected with a gas pipe Gp; one end of the gas pipe Gp is connected with a gas source G, and the other end of the gas pipe Gp is connected with the burners 11a and 11b. Thereby, the gas controller 30 can regulate the gas flow according to the control signal output by the signal processor 22. In one embodiment, the gas controller 30 is an analog gas controller or a multi-stage gas controller. For example, the analog gas controller is a gas controller ET-P-05-4025 by Clippard Inc., which determines the gas flow according to the value of the driving current; while the driving current is zero, the gas flow is also zero. Therefore, such a gas controller may function as a gas breaker. Refer to FIG. 3. The multi-stage gas controller may be a three-stage gas controller, which includes two control valves 30a and 30b connected in parallel and two sets of Y-shape branching devices. The flow rate of the control valve 30a is half that of the control valve 30b. For example, the flow rate of the control valve 30a is ¼ units, and the flow rate of the control valve 30b is ½ units. Via switching on/off the control valves 30a and 30b, the three-stage gas controller can output gas at a flow rate of 0, ¼, ½ or ¾ units, which is corresponding to a state of shutdown, low flame, medium flame or high flame. It can be understood: the control signal controlling the control valves 30a and 30b may be generated by the temperature sensor 20.

In the abovementioned structure, the signal processor 22 compares the sensing signal output by the thermopile sensor 21 with a preset temperature and generates an appropriate control signal to regulate the gas flow rate, i.e. adjust the flames of the burners, if the sensing signal exceeds the preset temperature. For an example, while the pot is heated without water thereinside, the gas stove is turned off. For another example, while the food inside the pot is boiling, the flames are weakened to save gas or avoid overflow of soup.

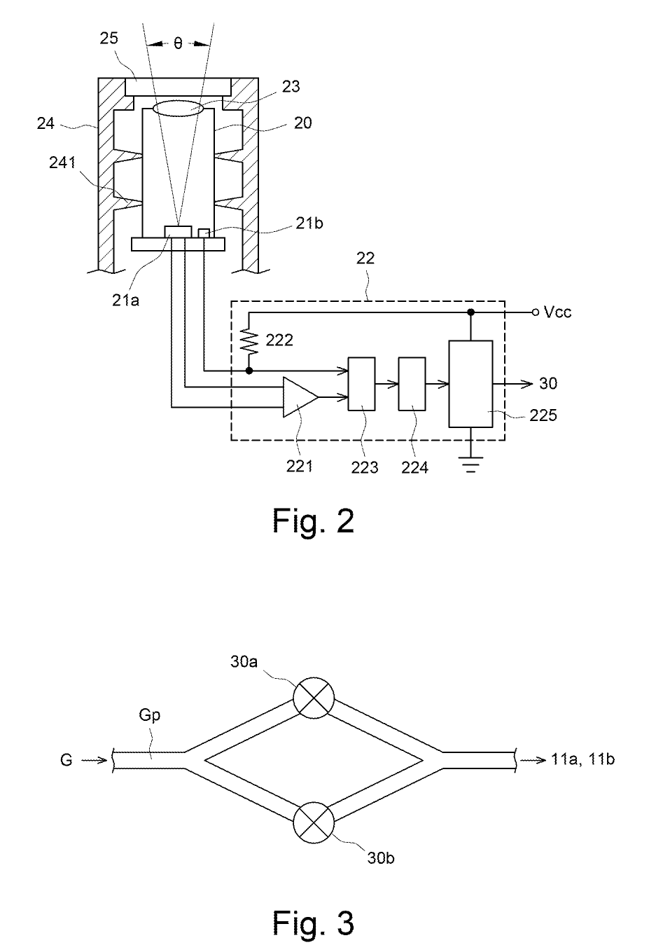

Refer to FIG. 2. The thermopile sensor 21 includes a thermopile sensing element 21a and a thermistor 21b. The thermistor 21b can compensate the thermopile sensing element 21a, whereby a more accurate measurement result is achieved. In one embodiment, the temperature sensor 20 further includes a lens 23 disposed at a receiving end of the thermopile sensing element 21a. The lens 23 features a long focal length, such as a focal length larger than 5 mm, and is used to limit the sensing angle θ within which the thermopile sensor 21 receives the infrared rays radiated by the pot 100, whereby to prevent the thermopile sensor 21 from sensing the temperature of the flames of the inner annular burner 11a. In other words, the thermopile sensor 21 can be disposed more close to the burners. Therefore, the gas stove of the present invention can be equipped with a plurality of burners, such as the inner annular burner 11a and the outer annular burner 11b, to output more heat energy. In one embodiment, the sensing angle is smaller than 20 degrees. For example, a lens 23 with a focal length of 5.8 mm has a sensing angle of about 7 degrees, wherefore the thermopile sensing element 21a would not sense the temperature of the flames but only senses the temperature of the pot bottom. The lens 23 is made of an infrared-permeable material, such as silicon or germanium, which allows the infrared rays having a wavelength of about 1-12 nm to pass. In one embodiment, the lens 23 is a silicon-based Fresnel lens. It can be understood: orientating the orifices 111 of the inner annular burner 11a slightly outwards can also prevent the thermopile sensor 21 from sensing the temperature of the flames of the inner annular burner 11a.

In one embodiment, the temperature sensor 20 includes a thermal insulation sleeve 24 having a window. The thermopile sensor 21 and the signal processor 22 are disposed inside the thermal insulation sleeve 24. The thermopile sensor 21 senses the infrared rays radiated by the pot through the window of the thermal insulation sleeve 24. In one embodiment, the thermal insulation sleeve 24 is made of a low temperature-sintered ceramic. In one embodiment, the inner wall of the thermal insulation sleeve 24 has a plurality of protrusions 241 contacting the thermopile sensor 21 for securing the thermopile sensor 21. It can be understood: the protrusions 241 on the inner wall of the thermal insulation sleeve 24, which are used to secure the thermopile sensor 21, can reduce the contact area between the thermopile sensor 21 and the inner wall of the thermal insulation sleeve 24 and decrease the heat energy conducted to the thermopile sensor 21 from the exterior of the thermal insulation sleeve 24. Besides, the air between the thermopile sensor 21 and the inner wall of the thermal insulation sleeve 24 also has a thermal insulation effect.

In one embodiment, the temperature sensor 20 includes a protection cover 25 disposed on the window of the thermal insulation sleeve 24. It can be understood: the protection cover 25 must be infrared-permeable. The protection cover 25 can protect the lens 23 or the thermopile sensing element 21a from being stained by dirt and favors accurate measurement of the thermopile sensor 21. The protection cover 25 needs swabbing often and thus demands higher wear-resistance. In one embodiment, the protection cover 25 is made of sapphire.

In one embodiment, the signal processor 22 includes a low noise voltage amplifier 221, a bias resistor 222, a signal multiplexer 223, an analog-to-digital converter 224, and a microcontroller 225. The bias resistor 222 is used to measure the resistance of the thermistor 21b for deducing the ambient temperature of the thermopile sensing element 21a to work out the actual temperature of the pot. The low noise voltage amplifier 221 is used to amplify the sensing signal output by the thermopile sensing element 21a. The signal multiplexer 223 is used to switch the signal from the thermistor 21b and the sensing signal amplified by the low noise voltage amplifier 221 and then sends the signal to the analog-to-digital converter 224. The analog-to-digital converter 224 converts the signal into a digital signal. The microcontroller 225 receives the digital signal, undertakes calculation and then makes decision. For example, while the temperature of the pot exceeds a present temperature, the microcontroller 225 outputs a control signal to the gas controller 30; the gas controller 30 regulates the gas flow rate to adjust the flames of the burners according to the control signal. In one embodiment, the output port of the microcontroller 225 is a digital output port, such an I²C (Inter-Integrated Circuit) port or a UART (Universal Asynchronous Receiver/Transmitter) port. In one embodiment, the output port of the microcontroller 225 is an analog voltage output port. In one embodiment, the output port of the microcontroller 225 is a logic I/O port.

It can be understood: the digital I/O port is a bidirectional I/O port. In other words, the microcontroller 225 not only can output temperature information or control signals to an external electronic device but also can receive control signals or setting parameters output by an external electronic device from a far end to adjust the parameters of the gas stove. For example, the user can turn off the gas stove or set the temperature conditions, such as the cooking temperature, the critical temperature of dry heating, the specification of the pot, or the radiation coefficient of the pot, from a far end. Thereby, the microcontroller 225 can adjust the radiation coefficient to work out the temperature information.

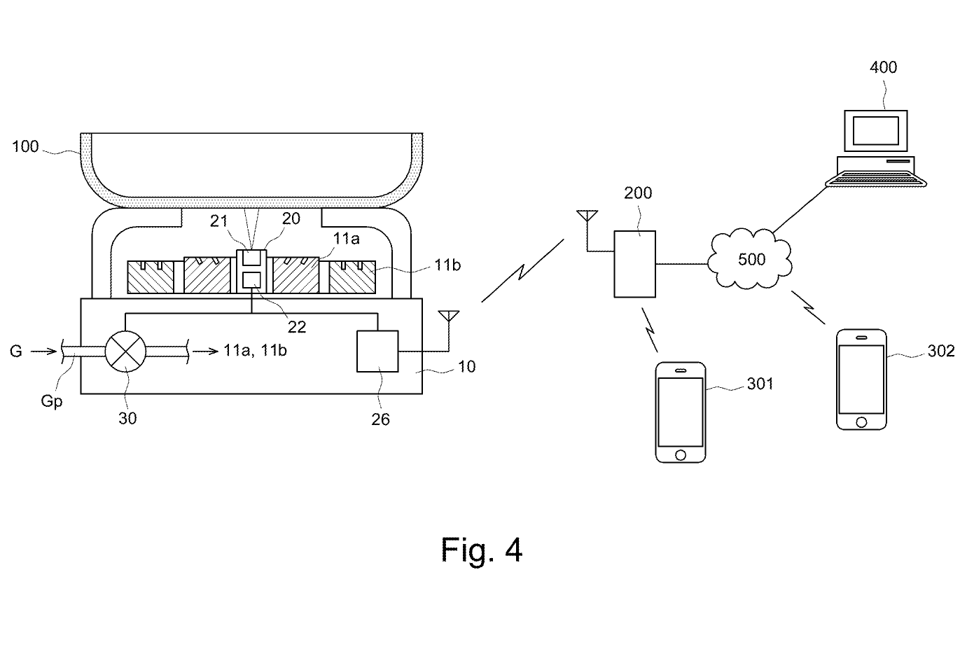

Refer to FIG. 4. In one embodiment, the temperature sensor 20 includes a wireless communication element 26 electrically connected with the signal processor 22. The wireless communication element 26 can wirelessly transmit the information of the sensed temperature to an external electronic device, such as a cloud server 400 or a far-end mobile Internet-access device 301 or 302. For example, while the temperature sensor 20 detects an abnormal temperature, the signal processor 22 can output a control signal to the gas controller 30 to weaken or turn off the flames; meanwhile, the signal processor 22 can link to the mobile Internet-access device 301 through the wireless communication element 26 and a gateway 200 or link to the cloud server 400 or the far-end mobile Internet-access device 302 through the Internet 500; thereby, the temperature information and the alert signal can be transmitted to the mobile Internet-access device 301, the cloud server 400, or the far-end mobile Internet-access device 302 to inform the user to deal with it immediately. As mentioned above, the user can also use the mobile Internet-access device 301 or 302 to set the temperature conditions, the specification of the pot or the radiation coefficient of the pot.

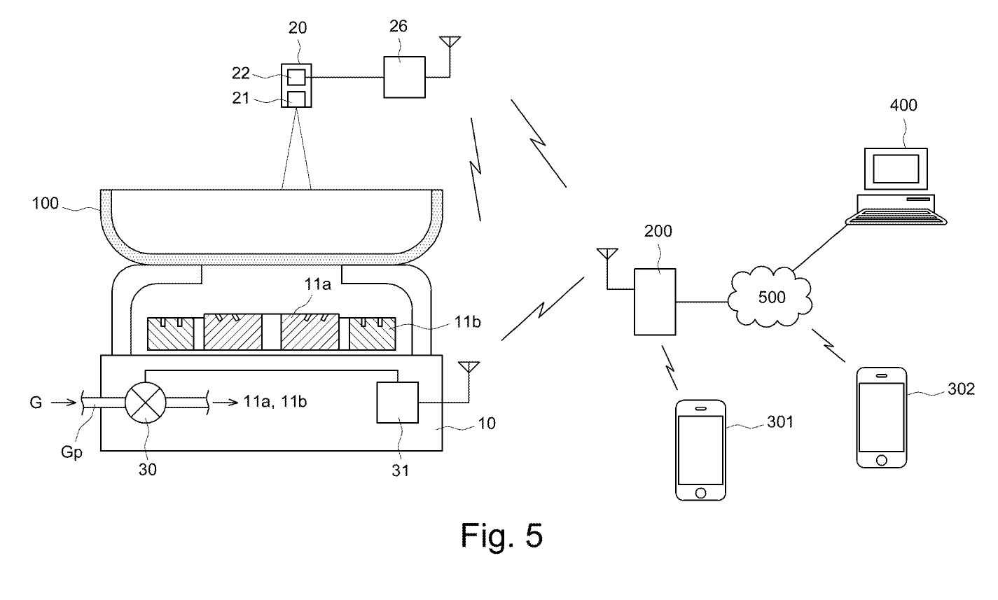

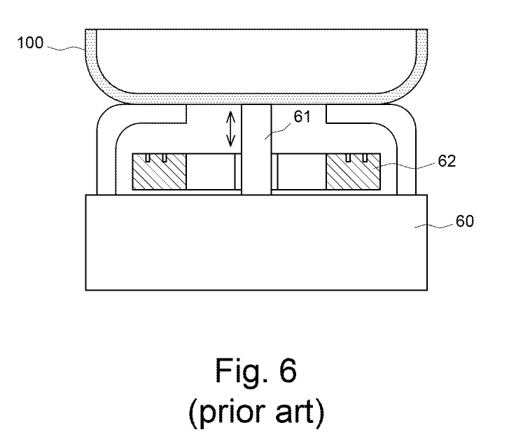

In the embodiments shown in FIG. 1 and FIG. 4, the temperature sensor 20 is built in the stove body 10. However, the present invention does not limit that the temperature sensor 20 must be built in the stove body 10. Refer to FIG. 5. In one embodiment, the temperature sensor 20 is separate from the stove body 10. In one embodiment, the temperature sensor 20 is integrated with an exhaust hood, detecting the pot temperature from the position above the gas stove. In one embodiment, the temperature sensor 20 is installed in another position and pointed to the side wall of the pot to detect the temperature of the side wall of the pot. It can be understood: the temperature sensor 20 in the embodiment shown in FIG. 5 needn't use the protection cover 25. In the embodiments shown in FIG. 5, the gas stove of the present invention comprises a first wireless communication element 31 electrically connected with the gas controller 30, and the temperature sensor 20 includes a second wireless communication element 26 electrically connected with the signal processor 22, whereby the signal processor 22 can wirelessly transmit the control signal to the gas controller 30 and also can wirelessly transmit the temperature information to an external electronic device, such as the mobile Internet-access device 301 or 302, or the cloud server 400, and whereby the user can also transmit the temperature setting conditions to the temperature sensor 20 or transmit the control signal to the gas controller 30 to directly regulate the flames through the mobile Internet-access device 301 or 302. In one embodiment, the gas controller 30 is separate from the stove body 10. If the temperature sensor 20 and the gas controller 30 mentioned in the abovementioned embodiments are installed in a conventional gas stove, the conventional gas stove is able to regulate flames, transmit temperature information to an external electronic device, and receive a far-end control signal from an external electronic device automatically.

In conclusion, the present invention uses a thermopile sensor to contactlessly sense the pot temperature, whereby is solved the conventional problem that inappropriate contact degrades measurement accuracy, wherefore is avoided dry heating of the pot. Further, the present invention uses a lens to limit the temperature sensor to detect the pot temperature within a narrower sensing angle, whereby is increased the flexibility of disposing the temperature sensor and decreased the interference of the flames, wherefore is achieved a more accurate measurement result. Furthermore, the present invention uses a wireless communication element to instantly transmit the pot temperature to a far-end server or mobile Internet-access device, whereby the user can undertake appropriate operation immediately, such as regulating/turning off flames or undertaking the next step in the cookbook.

What is claimed is:

1. A gas stove having a temperature sensing function, comprising:
a stove body, including a burner assembly for heating a pot;
a temperature sensor, including
a thermopile sensor, sensing infrared rays radiating from said pot and outputting a sensing signal; and
a signal processor, electrically connected with said thermopile sensor to process said sensing signal and output a control signal; and
a gas controller, electrically connected with said signal processor and adjusting a gas flow supplied to said burner assembly according to said control signal.

2. The gas stove having a temperature sensing function according to claim 1, wherein said temperature sensor further includes a lens disposed at a receiving end of said thermopile sensor and used to limit a sensing angle within which said thermopile sensor receives said infrared rays.

3. The gas stove having a temperature sensing function according to claim 2, wherein said sensing angle is smaller than 20 degrees.

4. The gas stove having a temperature sensing function according to claim 2, wherein said lens is made of silicon or germanium.

5. The gas stove having a temperature sensing function according to claim 2, wherein said lens is a silicon-based Fresnel lens.

6. The gas stove having a temperature sensing function according to claim 1, wherein said temperature sensor includes a thermal insulation sleeve having a window, and wherein said thermopile sensor and said signal processor are disposed inside said thermal insulation sleeve, and
wherein said thermopile sensor senses said infrared rays through said window.

7. The gas stove having a temperature sensing function according to claim 6, wherein an inner wall of said thermal insulation sleeve has a plurality of protrusions contacting said thermopile sensor for securing said thermopile sensor.

8. The gas stove having a temperature sensing function according to claim 6, wherein said temperature sensor includes a protection cover disposed on said window of said thermal insulation sleeve.

9. The gas stove having a temperature sensing function according to claim 8, wherein said protection cover is made of sapphire.

10. The gas stove having a temperature sensing function according to claim 1, wherein said thermopile sensor includes a thermopile sensing element and a thermistor.

11. The gas stove having a temperature sensing function according to claim 1, wherein said temperature sensor is disposed beside or among said burner assembly and pointed to a bottom of said pot.

12. The gas stove having a temperature sensing function according to claim 1, wherein said burner assembly includes an inner annular burner and an outer annular burner, which are disposed concentrically, and wherein said temperature sensor is disposed at a center of said inner annular burner and pointed to a bottom of said pot.

13. The gas stove having a temperature sensing function according to claim 12, wherein flames of said inner annular burner are orientated outward.

14. The gas stove having a temperature sensing function according to claim 1, wherein said gas controller is an analog gas controller or a multi-stage gas controller.

15. The gas stove having a temperature sensing function according to claim 1, wherein said temperature sensor includes a wireless communication element electrically connected with said signal processor for transmitting temperature information of said pot to an external electronic device or transmitting said control signal to said gas controller.

16. The gas stove having a temperature sensing function according to claim 15, wherein said wireless communication element receives setting parameters from said external electronic device for modifying parameters of said gas stove, and wherein said setting parameters include at least one of temperature conditions, a specification and a radiation coefficient of said pot.

17. The gas stove having a temperature sensing function according to claim 1 further comprising:
a first wireless communication element electrically connected with said gas controller, wherein said temperature sensor includes a second wireless communication element electrically connected with said signal processor for wirelessly transmitting said control signal to said gas controller, and wherein said temperature sensor is separated from said stove body and pointed to a top or a side wall of said pot.

18. The gas stove having a temperature sensing function according to claim 17, wherein said signal processor of said temperature sensor further outputs temperature information of said pot and transmits said temperature information to an external electronic device through said second wireless communication element.

19. The gas stove having a temperature sensing function according to claim 17, wherein said first wireless communication element establishes a wireless link to an external electronic device for receiving said control signal from said external electronic device.
